(19) United States
(12) Patent Application Publication
(10) Pub. No.: US 2026/0205507 A1
(43) Pub. Date: Jul. 16, 2026

(54) COMMUNICATING A PARTIAL SET OF ASSETS OF AN AVATAR FOR AN AUGMENTED REALITY COMMUNICATION SESSION

(71) Applicant: QUALCOMM Incorporated, San Diego, CA (US)

(72) Inventors: Imed Bouazizi, Celina, TX (US); Thomas Stockhammer, Bergen (DE); Liangping Ma, San Diego, CA (US)

(21) Appl. No.: 19/447,949

(22) Filed: Jan. 13, 2026

Related U.S. Application Data
(60) Provisional application No. 63/745,543, filed on Jan. 15, 2025.

(51) Int. Cl. H04L 65/75; G06T 13/40

(52) U.S. Cl. CPC H04L 65/75; G06T 13/40

(57) ABSTRACT

An example device for communicating augmented reality (AR) media data includes: a memory configured to store an avatar and selected assets for the avatar of a participant in an AR communication session; and a processing system implemented in circuitry and configured to: receive an avatar representation format (ARF) manifest file associated with an access token for a main ARF container including assets for the avatar associated with the participant in the AR communication session; receive data representing the selected assets for the avatar; send a request for the selected assets, the request including data representing the access token; and receive the selected assets in response to the request. The processing system may further receive an animation stream and animate the avatar and the selected assets during the AR communication session according to the animation stream.

This application claims the benefit of U.S. Provisional Application No. 63/745,543, filed January 15, 2025, the entire contents of which are hereby incorporated by reference.

### TECHNICAL FIELD

This disclosure relates to transport of media data, in particular, extended reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing augmented reality (AR) media data, such as extended reality (XR) media data. XR media data may include any or all of AR data, mixed reality (MR) data, or virtual reality (VR) data. This disclosure generally describes the use of AR data, although any of the various types of XR data may be used in addition or in the alternative. During an AR communication session, a user may be represented by an avatar. The avatar may correspond to a base model. Throughout the AR communication session, the user may move their body, face, hands, or the like. These movements may be tracked by various devices, and this tracked data may be used to animate the base model of the avatar. For example, the avatar may be animated to match movements of the user, facial expressions of the user, poses of the user, or the like. This disclosure describes techniques that may be used to convert from a tracking framework to a framework for the base model to better ensure that the base model can be properly animated.

In particular, this disclosure describes techniques for enabling partial access to avatar assets for augmented reality (AR) communication sessions. A participant in an AR session may be represented by an avatar, which may include a large collection of digital assets (e.g., various clothing items and accessories) stored in a main avatar representation format (ARF) container. To reduce consumption of bandwidth and storage during an AR communication session, a device may select a specific subset of these assets for use in the AR communication session. The device may generate an ARF manifest file describing the selected assets and an access token authorizing access to those specific assets. A peer device or server may then use the manifest and token to retrieve only the relevant assets from a base avatar repository, rather than downloading the entire main ARF container.

By enabling the retrieval of only a selected subset of assets via the ARF manifest file and access token, the techniques of this disclosure may reduce the amount of data transmitted during session initialization, compared to downloading the full main ARF container. This reduction in data transfer lowers bandwidth consumption and decreases startup latency, allowing for faster and more efficient session establishment. Additionally, coupling the asset selection with an access token enhances data security by enforcing granular access control, ensuring that access is limited to the specific assets authorized for the session are exposed to other participants, thereby protecting the full library of digital assets from unauthorized access.

In one example, a method of communicating augmented reality (AR) media data includes: receiving an avatar representation format (ARF) manifest file associated with an access token for a main ARF container including assets for an avatar associated with a participant in an AR communication session; receiving data representing selected assets for the avatar; sending a request for the selected assets, the request including data representing the access token; and receiving the selected assets in response to the request.

In another example, a device for communicating augmented reality (AR) media data includes: a memory configured to store AR media data; and a processing system implemented in circuitry and configured to: receive an avatar representation format (ARF) manifest file associated with an access token for a main ARF container including assets for an avatar associated with a participant in an AR communication session; receive data representing selected assets for the avatar; send a request for the selected assets, the request including data representing the access token; and receive the selected assets in response to the request.

In another example, a method of communicating augmented reality (AR) media data includes: receiving avatar configuration data representing a selection of selected assets from available assets for an avatar of a user, the avatar representing the user in a virtual scene for an AR communication session; creating an avatar representation format (ARF) manifest file including data representing the selection of selected assets from the available assets; and sending the ARF manifest file and an access token indicating that a participant in the AR communication session is authorized to access the selected assets to a base avatar repository.

In another example, a device for communicating augmented reality (AR) media data includes: a memory configured to store AR media data; and a processing system implemented in circuitry and configured to: receive avatar configuration data representing a selection of selected assets from available assets for an avatar of a user, the avatar representing the user in a virtual scene for an AR communication session; create an avatar representation format (ARF) manifest file including data representing the selection of selected assets from the available assets; and send the ARF manifest file and an access token indicating that a participant in the AR communication session is authorized to access the selected assets to a base avatar repository.

In another example, a method of communicating augmented reality (AR) media data includes: receiving, by an avatar repository device, an avatar representation format (ARF) manifest file and an access token from a first user equipment (UE) device associated with a user who participates in an AR communication session, the ARF manifest file representing a selection of assets for an avatar of the user to represent the user in a virtual scene for the AR communication session, the access token indicating that the selection of the assets can be retrieved by a participant in the AR communication session, the avatar repository device storing a main ARF container including the avatar and a full set of assets for the avatar; receiving, by the avatar repository device, a request to access the selection of the assets from a second UE device, the second UE device corresponding to the participant in the AR communication session, and the request including data corresponding to the access token; and in response to validating the access token, sending, by the avatar repository device, the selection of the assets to the second UE device.

In another example, a base avatar repository (BAR) device includes: a memory configured to store avatars and assets for the avatars; and a processing system implemented in circuitry and configured to: receive an avatar representation format (ARF) manifest file and an access token from a first user equipment (UE) device associated with a user who participates in an AR communication session, the ARF manifest file representing a selection of assets for an avatar of the user to represent the user in a virtual scene for the AR communication session, the access token indicating that the selection of the assets can be retrieved by a participant in the AR communication session, the avatar repository device storing a main ARF container including the avatar and a full set of assets for the avatar; receive a request to access the selection of the assets from a second UE device, the second UE device corresponding to the participant in the AR communication session, and the request including data corresponding to the access token, and in response to validating the access token, send the selection of the assets to the second UE device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques.

FIG. 3 is a flow diagram illustrating an example avatar animation workflow that may be used during an augmented reality (AR) session.

FIG. 4 is a flow diagram illustrating an example AR session between two user equipment (UE) devices and a shared space server device.

FIG. 5 is a block diagram illustrating an example user equipment (UE).

FIG. 6 is a block diagram illustrating an example set of devices that may perform various aspects of the techniques of this disclosure.

FIG. 7 is a conceptual diagram illustrating an example set of data that may be used in an AR session per techniques of this disclosure.

FIG. 8 is a flowchart illustrating an example method for partial access to an avatar representation format container per techniques of this disclosure.

FIG. 9 is a flowchart illustrating another example for partial access to an avatar representation format container per techniques of this disclosure.

FIG. 10 is a conceptual diagram illustrating an example graphical user interface (GUI) for selecting digital assets to be worn by an avatar of a user during an AR media communication session per techniques of this disclosure.

FIG. 11 is a flowchart illustrating an example method of receiving a selection of assets to be presented with an avatar during an AR communication session and authorizing access to the selected assets per techniques of this disclosure.

FIG. 12 is a flowchart illustrating an example method of retrieving assets to be presented with an avatar during an AR communication session per techniques of this disclosure.

FIG. 13 is a flowchart illustrating an example method of a base avatar repository (BAR) device receiving an avatar and assets for the avatar, authorization to access a selected subset of the assets, and sending the selected subset of the assets to a participant in an AR communication session per techniques of this disclosure.

### DETAILED DESCRIPTION

In general, this disclosure describes techniques for transporting and processing extended reality (XR) media data, such as augmented reality (AR) media data, mixed reality (MR) media data, or virtual reality (VR) media data. Immersive AR experiences are based on shared virtual spaces, where people (represented by avatars) join and interact with each other and the environment. Avatars may be realistic representations of the user or may be a “cartoonish” representation. Avatars may be animated to mimic the user’s body pose and facial expressions. Users may share pre-recorded or pre-defined base avatar models, which may be formatted according to specific technical standards. For example, the techniques of this disclosure may be implemented in accordance with the Third Generation Partnership Project (3GPP) Technical Specification (TS) 26.264, titled “Avatar Representation and Animation,” or the International Organization for Standardization / International Electrotechnical Commission (ISO/IEC) 23090-39 standard. These standards define example structures of the Avatar Representation Format (ARF) container and the mechanisms for animating the base avatar models during the AR session to represent movements of the corresponding user, such as hand gestures or facial expressions.

A display device (or another device) may capture facial movements of the user. For example, the display device may include one or more cameras or other sensors for detecting facial expressions and/or movements of the user, e.g., smiling, neutral, frowning, or mouth and jaw movements that occur when the user speaks. The display device may encode data representative of such facial movements and send the encoded data to a receiving device, such that the receiving device can animate the user’s avatar consistent with the user’s facial movements.

A receiving device may render received AR media data. Such rendering may be performed on a single device or using split rendering. A split rendering server may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The AR runtime may be configured to receive rendered data together with associated pose information (e.g., information indicating the predicted pose for which the rendered data was rendered) for proper composition and display. For instance, the AR runtime may need to perform pose correction to modify the rendered data according to an actual pose of the user at the display time.

Typical facial animation frameworks may include 50 to 80 blendshapes. Each blend shape may be a standalone mesh, referred to as a base mesh. The base mesh and its blendshapes may be available at different levels of detail (which may be retrieved according to, e.g., a distance between the viewer and the user in the virtual world/scene. Generally, the base model may be downloaded at the start of an AR communication session (or “AR call”). Therefore, the size of the base avatar may contribute significantly to the startup time of the call/communication session. A medium resolution/level of detail blendshape may range from 150 to 250 kB. Thus, with 50 to 80 blendshapes, the total size of the blendshapes could range between 7.5 MB to 20 MB, if sent uncompressed.

Before an AR call or communication session starts, each participant/user device may retrieve base avatar models of other participants in the AR communication session. The base avatar models may be stored in an avatar representation format (ARF) container. The ARF container may include assets related to the avatar and its animations, e.g., head, body, skeletons, and blendshape sets. The ARF container may further include other digital assets associated with the avatar, such as clothes, glasses, hats, and other garments. These assets may be stored redundantly with different levels of detail. However, not all of these assets need be shared with the participants in an AR communication session.

In general, users and user devices may share the relevant assets to perform animations, and nothing more. For example, only the clothes that a user chooses for an avatar during a call may be shared with call participants. Conventional ARF containers do not support partial access to avatar data and avatar accessory data, e.g., clothing, hats, glasses, etc. Thus, while an avatar may include a large set of assets, per techniques of this disclosure, a user equipment (UE) device may grant access to, and another UE device may access, only a subset of the available assets that are relevant to a current AR communication session.

In general, an asset repository device may store the full set of assets in a main avatar representation format (ARF) container. Rather than sending the entire main ARF container to a requesting UE device, the asset repository device may determine which assets have been selected for a current AR communication session and either receive or generate an access token associated with the selected assets. The asset repository device may then receive a request to access the selected assets. The request may include data for a request access token. The asset repository device may determine whether the request access token matches the access token associated with the selected assets. When the request access token matches the access token associated with the selected assets, the asset repository device may generate a temporary ARF container including only the selected assets and send the temporary ARF container to the requesting UE device.

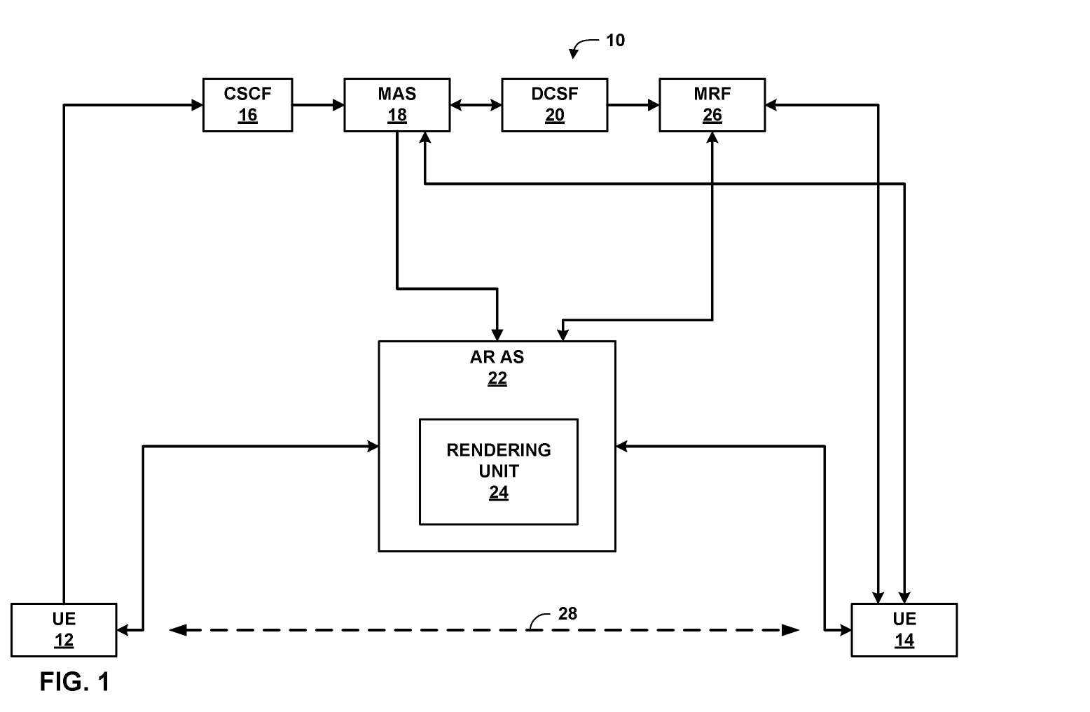

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user’s corresponding avatar may move according to the user’s movements or movement inputs. In some examples, the users’ avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if two-dimensional (2D) media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a personal computer (PC), laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

Per this disclosure, UEs 12, 14 may engage in an AR communication session. UEs 12, 14 may enable access to an avatar representation format (ARF) container. An ARF manifest may describe assets that other users are entitled to download. For example, UE 12 may provide an ARF manifest indicating assets that UE 14 is entitled to download, and UE 14 may provide an ARF manifest indicating assets that UE 12 is entitled to download. The ARF manifest(s) may be associated with respective access tokens that limit access to selected subsets of the ARF container for a limited period of time.

The ARF manifest may be a JavaScript Object Notation (JSON) document. The ARF manifest may contain data including any of: user information such as age, name, and/or gender; an identifier of a main ARF container; a list of asset identifiers, which may be described in the main ARF container; a subset of the level of details; a list of compressors to be used to decode the temporary ARF container; and/or digital rights management (DRM) protection information to gain access to the components of the temporary ARF container. In addition, the ARF manifest may include elements for tamper proofing. For example, the ARF manifest may include a signature with an owner’s private key of a hash of the ARF manifest or some elements, and the server may be able to verify the authenticity of the ARF manifest through decryption of the hash using the user’s public key.

In some examples, a session description protocol (SDP) attribute may signal an ARF manifest as being entitled to access to a temporary ARF container for other participants in an AR communication session. For example, the SDP attribute may be “a=arf-manifest: URL time frame.”

Scene description signaling may also be used. For example, the ARF manifest may be signaled through usage of the MPEG_node_avatar extension of the scene description. Instead of pointing to a base container, the extension may point into the ARF manifest. The receiver may parse the ARF manifest, determine whether the ARF manifest has the tools and rights to access the ARF container, and then send a request with the ARF manifest to create a temporary ARF container. The temporary ARF container may include only those assets selected for a current AR communication session. The request with the ARF manifest may further include a request access token. If the request access token matches an access token associated with the ARF manifest, the temporary ARF container may be delivered.

Techniques of this disclosure enabling communication of a partial set of assets via the ARF manifest file and the access token may reduce startup latency for AR communication session 28. Retrieving only the selected assets, rather than the entire main ARF container (which may exceed several gigabytes in size) may reduce bandwidth usage and storage requirements on UE 14. Additionally, separating the authorization for specific assets using the access token may provide granular security control, thereby preventing unauthorized access to the full wardrobe of the user of UE 12 while better ensuring peer devices receive the necessary data to render the avatar and assets correctly. These features may allow system 10 to establish high-fidelity avatar-based communications efficiently, even over networks with limited bandwidth.

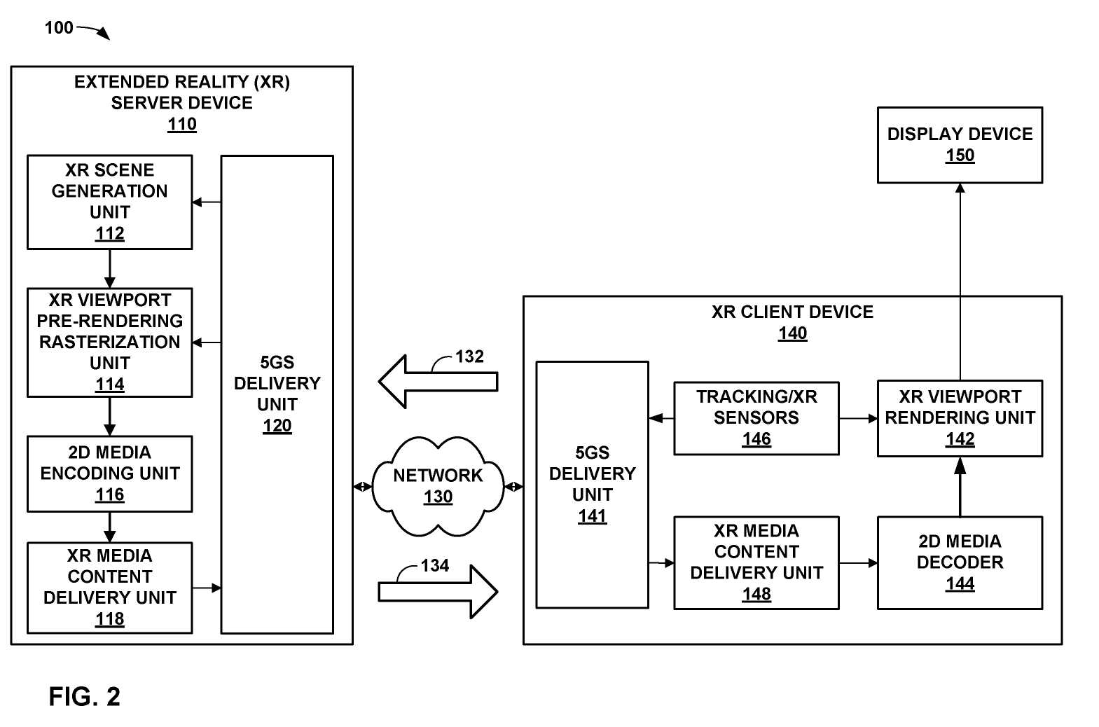

FIG. 2 is a block diagram illustrating an example computing system 100 that may perform split rendering techniques. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120. In some examples, XR server device 110 may correspond to AR AS 22 of FIG. 1, while XR client device 140 may correspond to UE 14 of FIG. 1. In some examples, XR server device 110 may represent a local computing device, while XR client device 140 represents a local UE device communicatively coupled to the local computing device via WiFi. In some examples, XR server device 110 may correspond to a UE device, while XR client device 140 may correspond to an HMD also including display device 150.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user’s viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user’s viewport and location, and then pre-render 2D media data for the user’s viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

In some examples, XR server device 110 may receive an avatar representation format (ARF) manifest file representing a set of selected assets to be presented with an avatar, and an access token, from a user of a peer client device participating in an AR communication session. The ARF manifest file may include data representing a network location of a base avatar repository (BAR) that hosts the avatar and the assets for the avatar. Additionally, the ARF manifest file may include one or more of user information for the participant, an identifier of the main ARF container, a list of asset identifiers for the selected assets, data representing available levels of detail (LOD), data representing compressors to be used to decode the avatar and the selected assets, or digital rights management (DRM) information for gaining access to the avatar and the selected assets. XR server device 110 may request the selected assets and the avatar from the BAR. For example, XR server device 110 may send the ARF manifest file and the access token to the BAR to retrieve the avatar and the selected assets. XR server device 110 may also receive an animation stream from the peer client device. XR server device 110 may then render the avatar and the selected assets using the animation stream and provide the rendered media data to XR client device 140.

Providing XR server device 110 with the ARF manifest file may allow XR server device 110 to retrieve only the subset of selected assets from the base avatar repository, rather than the entire main ARF container, thereby reducing bandwidth consumption and improving startup latency for the AR communication session. Additionally, utilizing the access token to authorize retrieval of the selected assets enhances data security by enforcing granular access control, ensuring that only the specific assets intended for the session are exposed to XR server device 110 or other peer devices. These features may collectively enable efficient, secure, and high-fidelity avatar rendering in split-rendering environments.

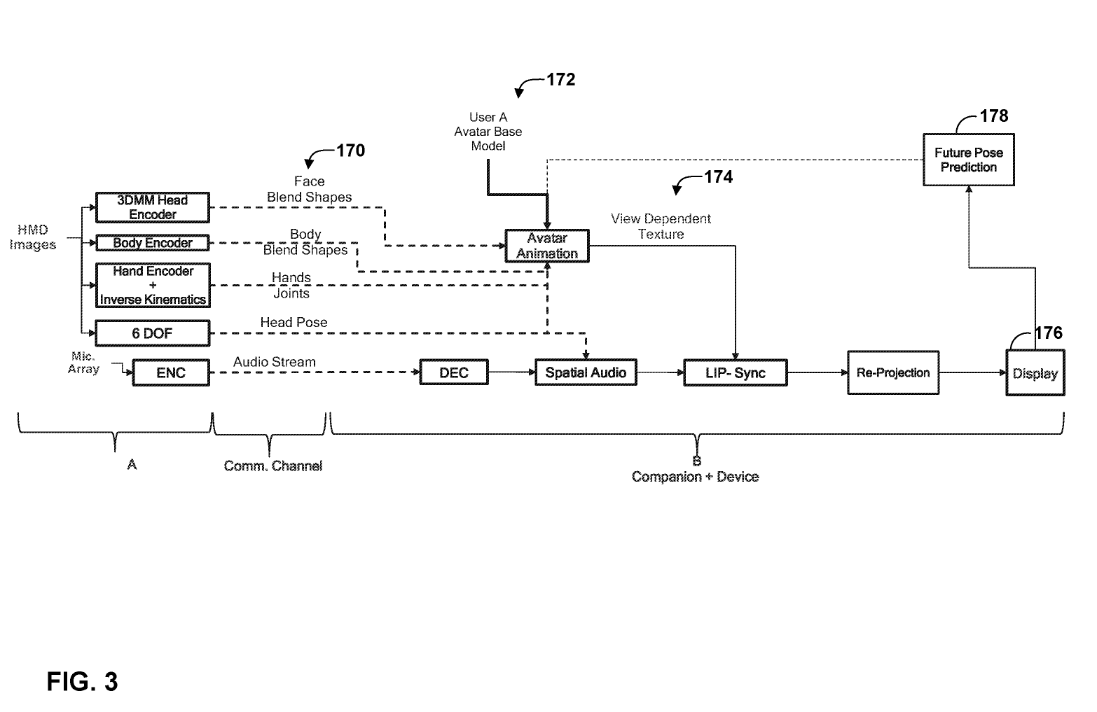

FIG. 3 is a flow diagram illustrating an example avatar animation workflow that may be used during an AR session. In this example, received animation stream data 170 includes face blendshapes, body blendshapes, hand joints, head pose, and audio stream data. The face blendshapes, body blendshapes, and hand joints may correspond to animation streams to be applied to user A avatar base model 172. In particular, data for user A avatar base model 172 may be stored at various levels of detail, per the techniques of this disclosure. Thus, rendering components 174 may retrieve data of user A avatar base model 172 at an appropriate level of detail, e.g., based on a distance between a current user and user A in a 3D space. Rendering components 174 may then animate the avatar base model using received animation stream data 170. Ultimately, the animated avatar base model may be presented to the current user via display 176. In addition, movement data of the current user may be used to predict a future pose of the user by future pose prediction unit 178.

Rendering components 174 may receive an avatar representation format (ARF) manifest file associated with an access token for a main ARF container. The main ARF container may be stored at the BAR and include the avatar and a full set of assets for the avatar. Rendering components 174 may send a request for the selected set of assets to the BAR, the request including data representing the access token. The request may further include a request for the avatar. Rendering components 174 may receive the selected set of assets and a base mesh for the avatar in response to the request. Rendering components 174 may receive the animation stream from a peer network device of a participant in the AR session. Rendering components 174 may animate the avatar, including animating the selected set of assets, according to the animation stream.

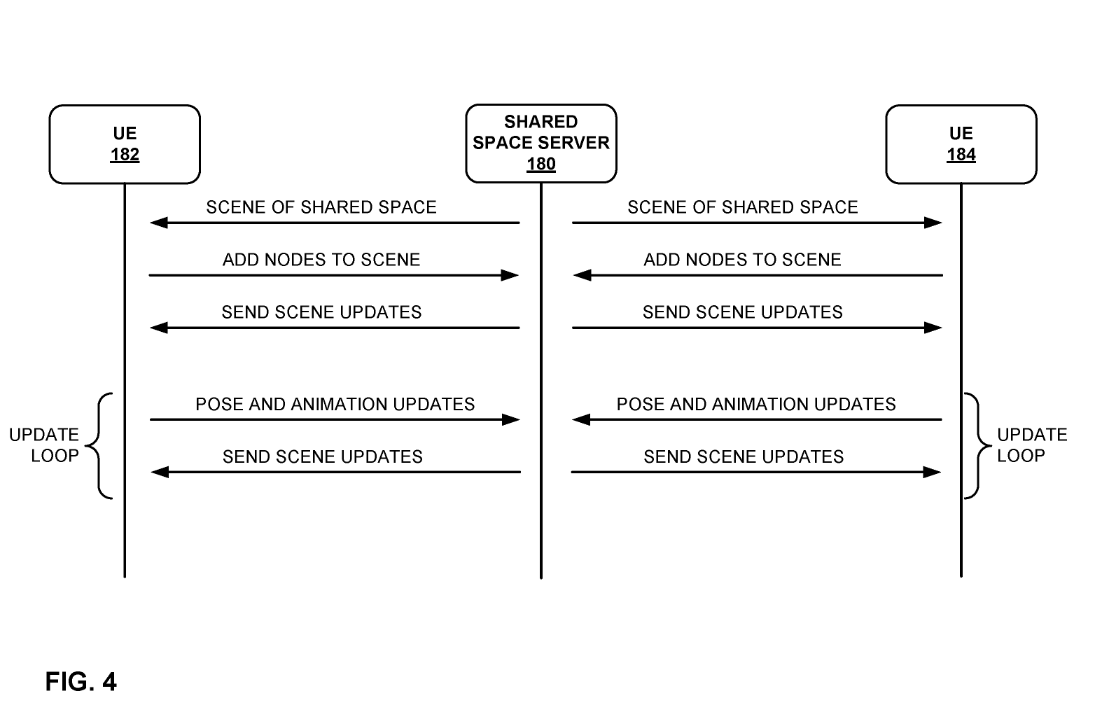

FIG. 4 is a flow diagram illustrating an example AR session between two user equipment (UE) devices 182, 184 and shared space server 180. UEs 182, 184 may correspond to, for example, UEs 12, 14 of FIG. 1. Either or both of UEs 182, 184 may be communicatively coupled to a split rendering server, such as AR AS 22 of FIG. 1 or XR server device 110 of FIG. 2.

As shown in the example of FIG. 4, two or more UEs may participate in an AR session. The UEs may send and receive data representative of their animation streams and other 3D model data to and from a shared space server. For example, various sensors such as cameras, trackers, Light Detection and Radar (LIDAR), or the like, may track user movements, such as facial movements (e.g., during speech or as emotional reactions), hand movements, walking movements, or the like. These movements may be translated into an animation stream by, e.g., UE 182 and sent to shared space server 180. Shared space server 180 may then send the animation stream to UE 184.

UE 182 may represent an example of a device configured to receive avatar configuration data representing a selection of selected assets from available assets for an avatar of a user. The avatar represents the user in a virtual scene for the AR communication session. UE 182 may create an avatar representation format (ARF) manifest file including data representing the selection of selected assets from the available assets. UE 182 may send the ARF manifest file and an access token indicating that a participant in the AR communication session (e.g., UE 184) is authorized to access the selected assets to a base avatar repository. In some examples, shared space server 180 may include the base avatar repository. In some examples, the base avatar repository may be separate from the base avatar repository.

UE 184 may represent an example of a device configured to receive the ARF manifest file associated with the access token for a main ARF container including assets for the avatar. UE 184 may receive data representing the selected assets for the avatar, e.g., in the ARF manifest file. UE 184 may send a request for the selected assets including data representing the access token. For example, UE 184 may send the ARF manifest file and the access token to the base avatar repository. UE 184 may receive the selected assets in response to the request. The base avatar repository (e.g., shared space server 180) may receive the request to access the selection of the assets from UE 184. In response to validating the access token, the base avatar repository may send the selected assets and the avatar to UE 184. During the AR communication session, UE 184 may animate the avatar, including animating the selected assets, according to an animation stream received from UE 182 (e.g., during the update loop shown in FIG. 4).

Transmitting the ARF manifest file and the access token in this manner, instead of the complete main ARF container, allows the system of FIG. 4 to reduce data transfer overhead, thereby reducing latency during the initialization of the AR communication session. This approach may also ensure that UE 184 retrieves only the specific assets used for the current session from the base avatar repository, avoiding the bandwidth consumption associated with downloading the full set of available assets. Furthermore, coupling the selected assets with the access token may enhance security by enforcing granular access control, preventing unauthorized participants from accessing the entire library of digital assets, while enabling the authorized rendering of the selected avatar configuration.

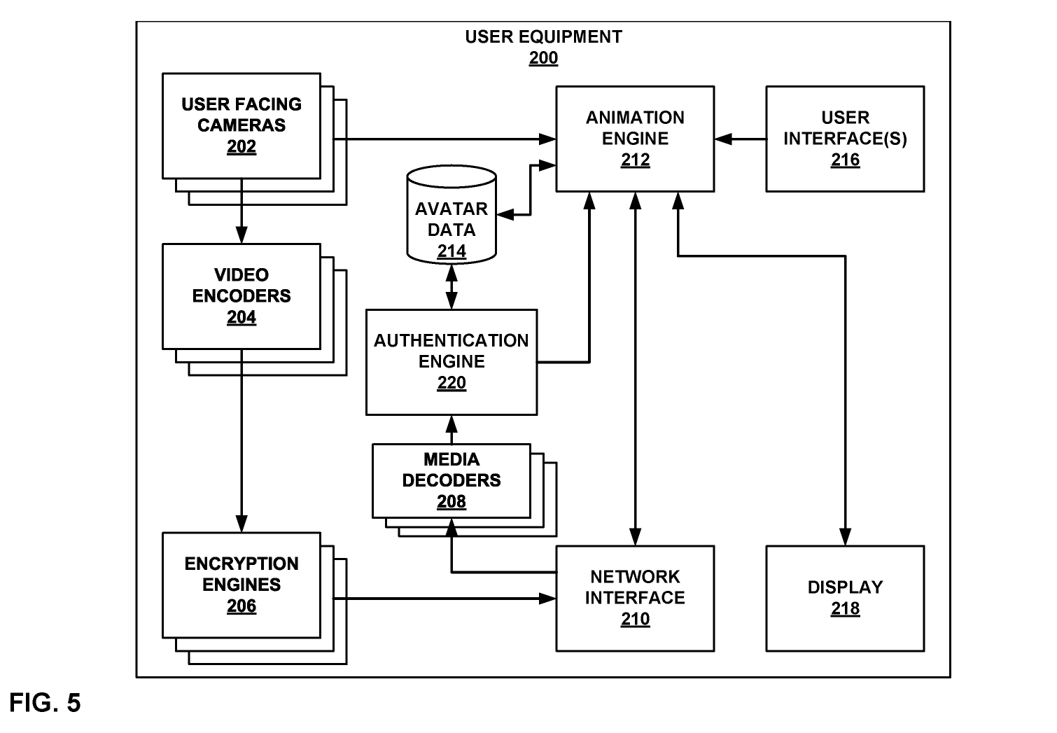

FIG. 5 is a block diagram illustrating an example user equipment (UE) 200. UEs 12, 14 of FIG. 1, and/or UEs 182, 184 of FIG. 4, may include components similar to those of UE 200. In general, a participant device may both send and receive content during an AR communication session. In this example, UE 200 includes user facing cameras 202, video encoders 204, encryption engines 206, media decoders 208, network interface 210, authentication engine 220, avatar data 214, animation engine 212, user interface(s) 216, and display 218.

A user may use UE 200 to participate in an AR communication session, e.g., to both send and receive AR data with one or more other participants in the AR communication session. For example, UE 200 may receive inputs from the user via user interface(s) 216, which may correspond to buttons, controllers, track pads, joysticks, keyboards, sensors, or the like. Such inputs may represent, for example, movements of the user in real-world space to be translated into the virtual scene, such as locomotive movement, head movements, eye movements (captured by user facing cameras 202), or interactions with the various buttons or other interface devices.

Animation engine 212 may receive such inputs and determine how to animate a user’s avatar, stored in avatar data 214. For example, such animations may include locomotive animations (walking or running), arm movement animations, hand movement animations, finger movement animations, and/or facial expression change animations. Animation engine 212 may provide animation information to network interface 210 for output to other participants in the AR communication session, along with other information such as, for example, interactions with virtual objects, movement direction, viewport, or the like.

In addition, per the techniques of this disclosure, user facing cameras 202 may provide one or more video streams of a user’s face to video encoder(s) 204 to form an encoded video stream, which may be encrypted by encryption engine(s) 206 or sent unencrypted. That is, one or more video streams capturing distinguishing features of the user’s face or other objects of interest (e.g., background objects, location-identifying objects, unique identifiers, or the like) may be sent via network interface 210 to one or more other participants in the AR communication session. When the user is wearing a head-mounted display (HMD), the HMD may be configured to capture only parts of the user’s face by user-facing cameras 202 of the HMD (e.g., eyes and mouth may be captured as three distinct streams). Such video streams (which may further be encrypted) may be provided to network interface 210 and sent to other participants in the AR communication session, such that the UEs of the other participants can authenticate that the avatar data is actually coming from the user of UE 200, per the techniques of this disclosure. In general, the distinguishing features may be any one or more elements of a person, location, object, or the like that may be used to uniquely identify the target person, location, or object and to associate the avatar (or other 3D object) with the target person, location, or object.

Similarly, UE 200 may receive encrypted video stream(s) from the other participants in the AR communication session. UE 200 may decrypt and then decode the video stream(s) using media decoders 208, which may provide the decrypted video streams to authentication engine 220. Per the techniques of this disclosure, authentication engine 220 may compare data of the received video streams to authentication data associated with an avatar of the other user being authenticated, stored with avatar data 214.

As an example, authentication engine 220 may include a deep learning algorithm, e.g., an artificial intelligence/machine learning (AI/ML) model trained to extract facial features. The facial features may be a vector of values, e.g., 568 values, that provide a latent representation of a face. Distances to the facial features may be stored in the base avatar model as part of avatar data 214. Authentication engine 220 may calculate distances between facial features extracted from the received video bitstream(s) and compare these distances to the distances stored as part of avatar data 214, to determine if the user’s face is the same as that of the user associated with the avatar. In addition to, or in the alternative to, facial features, other features may be used, such as 3D head features, vocal features, and/or light environments.

In addition to the authentication features, UE 200 may perform techniques for communicating AR media data using a partial set of assets per techniques of this disclosure. UE 200 may receive avatar configuration data representing a selection of selected assets from available assets for an avatar of a user, e.g., via a graphical user interface (GUI) from the user. The avatar represents the user in a virtual scene for an AR communication session. UE 200 may then create an avatar representation format (ARF) manifest file including data representing the selected assets from the available assets. UE 200 sends the ARF manifest file and an access token indicating that one or more other participants in the AR communication session are authorized to access the selected assets to a base avatar repository.

UE 200 may also send the ARF manifest file and the access token to peer UEs of the one or more other participants. Sending the ARF manifest file may include sending a session description protocol (SDP) message including an SDP attribute indicating the ARF manifest file. The SDP attribute may have a format of “a=arf-manifest: URL time-frame.”

In some examples, this SDP message is encapsulated within a SIP INVITE request or a SIP OFFER message sent by UE 200 via network interface 210 to initiate the AR communication session. By including the SDP attribute in the initial SIP signaling, UE 200 allows the receiving peer or server to retrieve the selected assets and the avatar from the base avatar repository before the media plane is fully established. This better ensures that the avatar representation is ready for rendering as soon as the session is active, thereby reducing visual latency.

UE 200 may sign a hash of at least a portion of the ARF manifest file with a private key of the user to form a signature for the ARF manifest file. UE 200 may send the signature for the ARF manifest file to the base avatar repository to authenticate the access token.

UE 200 may determine movements of the user during the AR communication session, such as body movements and/or facial movements. UE 200 may generate an animation stream representing the movements of the user, e.g., including blendshapes for facial movements and joint rotations for body movements. UE 200 may send the animation stream to the peer network devices of the participants in the AR communication session to cause the peer network devices to animate the avatar and the selected assets according to the animation stream.

The ARF manifest file may include one or more of user information for the user, an identifier of a main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets.

In some examples, UE 200 may also (additionally or alternatively) operate as a receiving device during the AR communication session. UE 200 may receive an avatar representation format (ARF) manifest file associated with an access token for a main ARF container including assets for an avatar associated with a participant in the AR communication session. UE 200 may receive data representing selected assets for the avatar. UE 200 may receive the ARF manifest file and the data representing the selected assets from a peer network device of the participant. UE 200 may use the ARF manifest file to determine a network location of a base avatar repository (BAR) that hosts the avatar and the assets for the avatar. UE 200 may send a request for the selected assets to the BAR indicated in the ARF manifest file. The request may include data representing the access token. UE 200 may receive the selected assets in response to the request. The request may further comprise a request for the avatar, and UE 200 may receive a base mesh for the avatar. UE 200 may receive an animation stream from the peer network device and animate the avatar, including animating the selected assets, according to the animation stream.

In this manner, UE 200 represents an example of a device for communicating augmented reality (AR) media data, including: a memory configured to store AR media data; and a processing system implemented in circuitry and configured to: receive an avatar representation format (ARF) manifest file associated with an access token for a main ARF container including assets for an avatar associated with a participant in an AR communication session; receive data representing selected assets for the avatar; send a request for the selected assets, the request including data representing the access token; and receive the selected assets in response to the request.

UE 200 also represents an example of a device for communicating augmented reality (AR) media data, including: a memory configured to store AR media data; and a processing system implemented in circuitry and configured to: receive avatar configuration data representing a selection of selected assets from available assets for an avatar of a user, the avatar representing the user in a virtual scene for an AR communication session; create an avatar representation format (ARF) manifest file including data representing the selection of selected assets from the available assets; and send the ARF manifest file and an access token indicating that a participant in the AR communication session is authorized to access the selected assets to a base avatar repository.

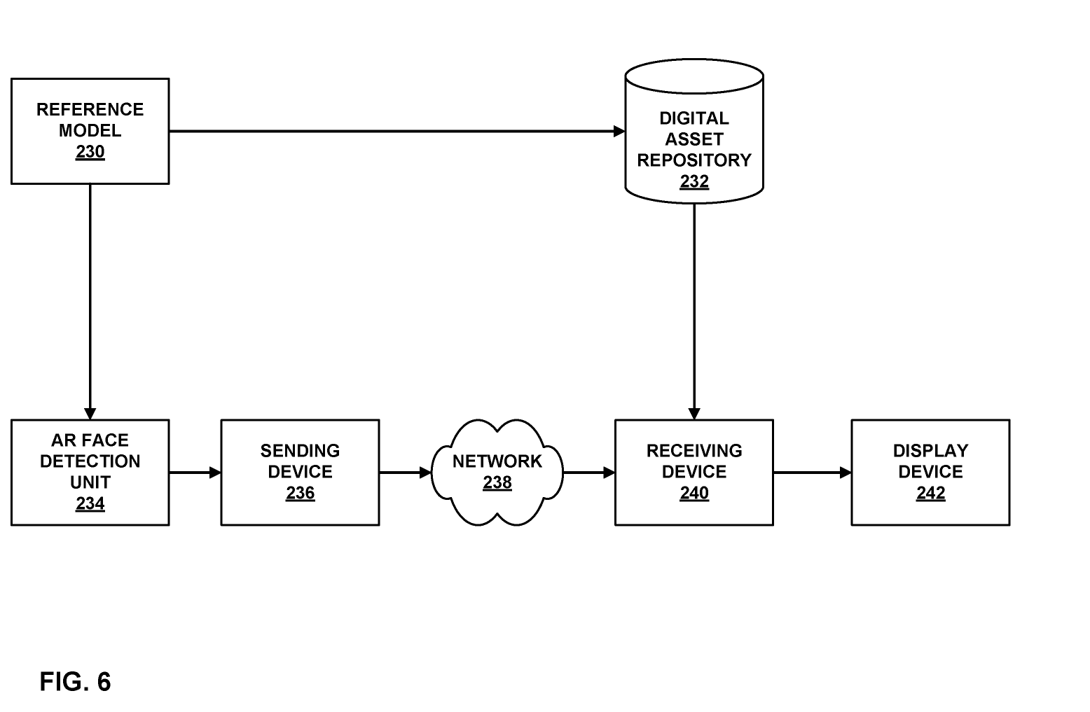

FIG. 6 is a block diagram illustrating an example set of devices that may perform various aspects of the techniques of this disclosure. The example of FIG. 6 depicts reference model 230, digital asset repository (DAR) device 232, AR face detection unit 234, sending device 236, network 238, receiving device 240, and display device 242. Sending device 236 may correspond to UE 12 of FIG. 1 or UE 182 of FIG. 4, and receiving device 240 may correspond to UE 14 of FIG. 1, XR client device 140 of FIG. 2, or UE 184 of FIG. 4. Furthermore, sending device 236 and/or receiving device 240 may include components similar to those of UE 200 of FIG. 5.

Sending device 236 and receiving device 240 may represent user equipment (UE) devices, such as smartphones, tablets, laptop computers, personal computers, or the like. AR face detection unit 234 may be included in an AR display device, such as an AR headset, which may be communicatively coupled to sending device 236. Likewise, display device 242 may be an AR display device, such as an AR headset.

In this example, reference model 230 includes model data for a human body and face. DAR device 232 may include avatar data for a user, e.g., a user of sending device 236. DAR device 232 may store the avatar data in a base avatar format. The base avatar format may differ based on software used to form the base avatar, e.g., modeling software from various vendors.

Reference model 230 may also be communicatively coupled to digital asset repository device 232 to define a standardized structure for the stored assets. For example, digital asset repository device 232 may utilize the bone hierarchy, joint definitions, and mesh topology defined by reference model 230 to validate incoming assets or to ensure that the assets stored in the main ARF container are compatible with the animation streams generated by sending device 236. This alignment better ensures that when receiving device 240 retrieves the selected assets, they can be correctly mapped to the animation data derived from reference model 230.

AR face detection unit 234 may detect facial expressions of a user and provide data representative of the facial expressions to sending device 236. Sending device 236 may encode the facial expression data and send the encoded facial expression data to receiving device 240 via network 238. Network 238 may represent the Internet or a private network (e.g., a virtual private network (VPN)). Receiving device 240 may decode and reconstruct the facial expression data and use the facial expression data to animate the avatar of the user of sending device 236.

Various facial and body tracking units may perform facial and body tracking in different ways, which may vary widely according to a solution being sought. For example, various facial and body tracking units may be configured with different numbers of blendshapes with different sets of expressions and/or different rigs (that is, 3D models of joints and bones) with different sets of bones and joints and different bone dimension. Some facial expressions and bones/joints do not exist in certain solutions but do exist in other solutions.

Sending device 236 may represent an example of a user equipment (UE) device configured to receive avatar configuration data representing a selection of selected assets from available assets for an avatar of a user. The avatar represents a user of sending device 236 in a virtual scene for the AR communication session. Initially, the user may select assets of a set of available assets for the avatar as a set of selected assets. Sending device 236 may create an ARF manifest file including data representing selected assets. Sending device 236 may send the ARF manifest file and an access token indicating that another participant (e.g., a user of receiving device 240) in the AR communication session is authorized to access the selected assets to DAR device 232.

Sending device 236 may sign a hash of at least a portion of the ARF manifest file with a private key of the user to form a signature for the ARF manifest file and also send the signature for the ARF manifest file to DAR device 232. DAR device 232 may operate as a base avatar repository. Sending device 236 may also send the ARF manifest file to receiving device 240, which operates as a peer network device in the AR communication session. Sending device 236 may send the ARF manifest file via a session description protocol (SDP) message including an SDP attribute indicating the ARF manifest file.

Receiving device 240 may represent an example of a device configured to receive the ARF manifest file associated with the access token, the ARF manifest file including selected assets for an avatar representing the user of sending device 236 during the AR communication session. The ARF manifest file may include data representing a network location of DAR device 232. Receiving device 240 may send a request for the selected assets to DAR device 232, the request including data representing the access token. The request may also include the ARF manifest file or data corresponding to the ARF manifest file. Receiving device 240 may receive the selected assets in response to the request from DAR device 232.

DAR device 232 may represent an example of an avatar repository device configured to receive the ARF manifest file and the access token from sending device 236. DAR device 232 may store the main ARF container including the avatar and a full set of assets for the avatar. DAR device 232 may receive the request to access the selection of the assets from receiving device 240. In response to validating the access token, DAR device 232 may send the selection of the assets to receiving device 240. DAR device 232 may generate a temporary ARF container including the selection of the assets and excluding other assets of the main ARF container. DAR device 232 may send the temporary ARF container to receiving device 240.

To initially validate the ARF manifest file, DAR device 232 may receive the signature of the hash of the ARF manifest file from sending device 236. DAR device 232 may apply a public key of the user of sending device 236 to the signature to produce a reconstructed hash value. DAR device 232 may calculate a calculated hash value of the at least portion of the ARF manifest file. DAR device 232 may verify the ARF manifest file as belonging to the user of sending device 236 when the calculated hash value matches the reconstructed hash value. The ARF manifest file may include one or more of user information, an identifier of the main ARF container, a list of asset identifiers, available levels of detail (LOD), compressors, and/or digital rights management (DRM) information.

In this manner, receiving device 240 represents an example of a device for communicating augmented reality (AR) media data, including: a memory configured to store AR media data; and a processing system implemented in circuitry and configured to: receive an avatar representation format (ARF) manifest file associated with an access token for a main ARF container including assets for an avatar associated with a participant in an AR communication session; receive data representing selected assets for the avatar; send a request for the selected assets, the request including data representing the access token; and receive the selected assets in response to the request.

Likewise, sending device 236 represents an example of a device for communicating augmented reality (AR) media data, including: a memory configured to store AR media data; and a processing system implemented in circuitry and configured to: receive avatar configuration data representing a selection of selected assets from available assets for an avatar of a user, the avatar representing the user in a virtual scene for an AR communication session; create an avatar representation format (ARF) manifest file including data representing the selection of selected assets from the available assets; and send the ARF manifest file and an access token indicating that a participant in the AR communication session is authorized to access the selected assets to a base avatar repository.

Moreover, DAR device 232 represents an example of a base avatar repository (BAR) device, including: a memory configured to store avatars and assets for the avatars; and a processing system implemented in circuitry and configured to: receive an avatar representation format (ARF) manifest file and an access token from a first user equipment (UE) device associated with a user who participates in an AR communication session, the ARF manifest file representing a selection of assets for an avatar of the user to represent the user in a virtual scene for the AR communication session, the access token indicating that the selection of the assets can be retrieved by a participant in the AR communication session, the avatar repository device storing a main ARF container including the avatar and a full set of assets for the avatar; receive a request to access the selection of the assets from a second UE device, the second UE device corresponding to the participant in the AR communication session, and the request including data corresponding to the access token, and in response to validating the access token, send the selection of the assets to the second UE device.

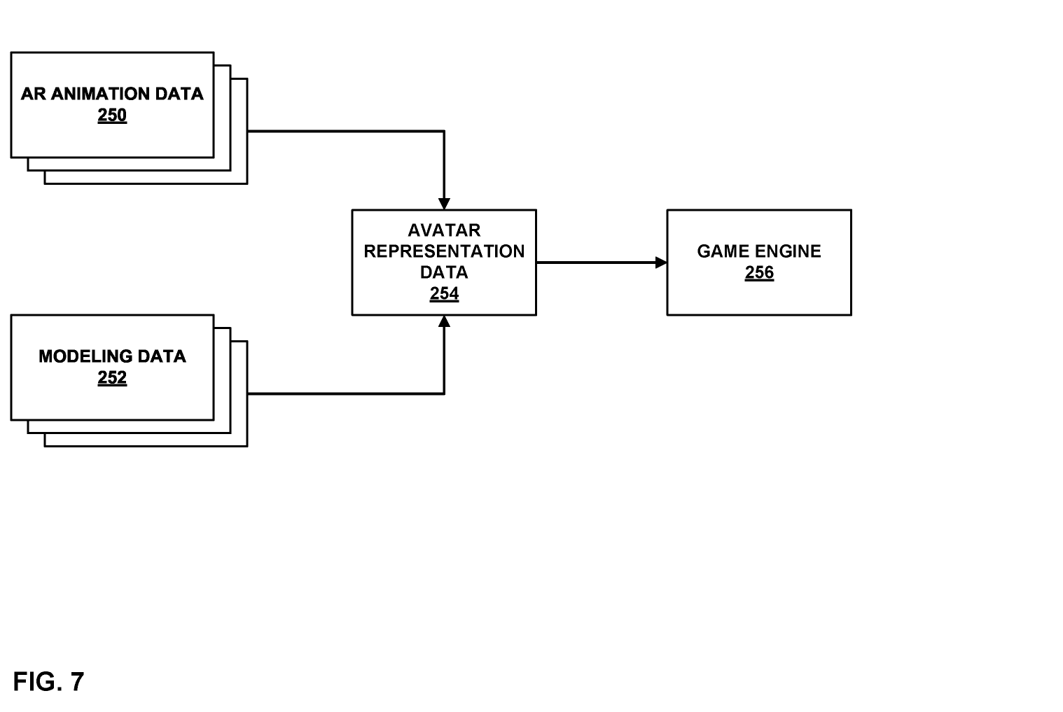

FIG. 7 is a conceptual diagram illustrating an example set of data that may be used in an AR session per techniques of this disclosure. In this example, FIG. 7 depicts AR animation data 250, modeling data 252, avatar representation data 254, and game engine 256. Modeling data 252 may represent one or more sets of data used to form a base avatar model, which may originate from various sources, such as modeling software (e.g., Blender or Maya), Graphics Language Transmission Format (glTF), universal scene description (USD), VRM Consortium, MetaHuman, or the like. AR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, a Third Generation Partnership Project (3GPP) engine, or the like.

Modeling data 252 may correspond to the avatar and the selected assets from the main ARF container at the base avatar repository. Modeling data 252 may include assets such as the base mesh, blendshapes, skeleton, joints, and various accessory assets selected by the user of the avatar. Avatar representation data 254 may result from the retrieval of selected assets using the ARF manifest file and the access token in combination with AR animation data 250. A user device (e.g., executing game engine 256) may receive the ARF manifest file associated with the access token. The ARF manifest file may include the identifier of the main ARF container and the list of asset identifiers for the selected assets. The user device may send the request including the access token to the base avatar repository to retrieve the specific subset of modeling data 252 defined by the selected assets. The specific subset forms part of avatar representation data 254.

Game engine 256 may receive AR animation data 250 as the animation stream from the peer network device. Game engine 256 may animate the avatar and the selected assets according to the animation stream. The ARF manifest file may further specify available levels of detail (LOD), compressors, or digital rights management (DRM) information to be used by game engine 256 to correctly decode and render avatar representation data 254.

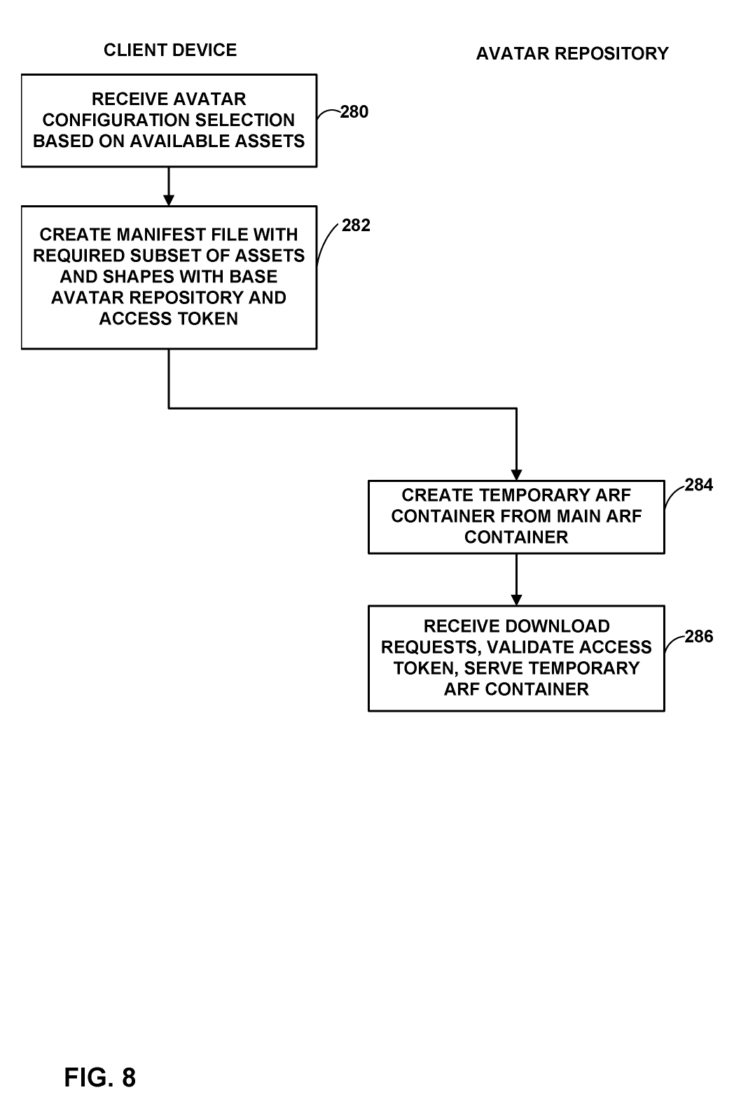

FIG. 8 is a flowchart illustrating an example method for partial access to an avatar representation format container per techniques of this disclosure. In this example, initially, a client device receives an avatar configuration selection based on available assets (280). The client device then creates a manifest file (e.g., a media presentation description, MPD) with a required subset of assets and shapes with a base avatar repository and an access token (282).

An avatar repository then creates a temporary avatar representation format (ARF) container from the main ARF container of the client device (284). The avatar repository then receives download requests from other users of the AR communication session, validates an access token, and serves the temporary ARF container (286).

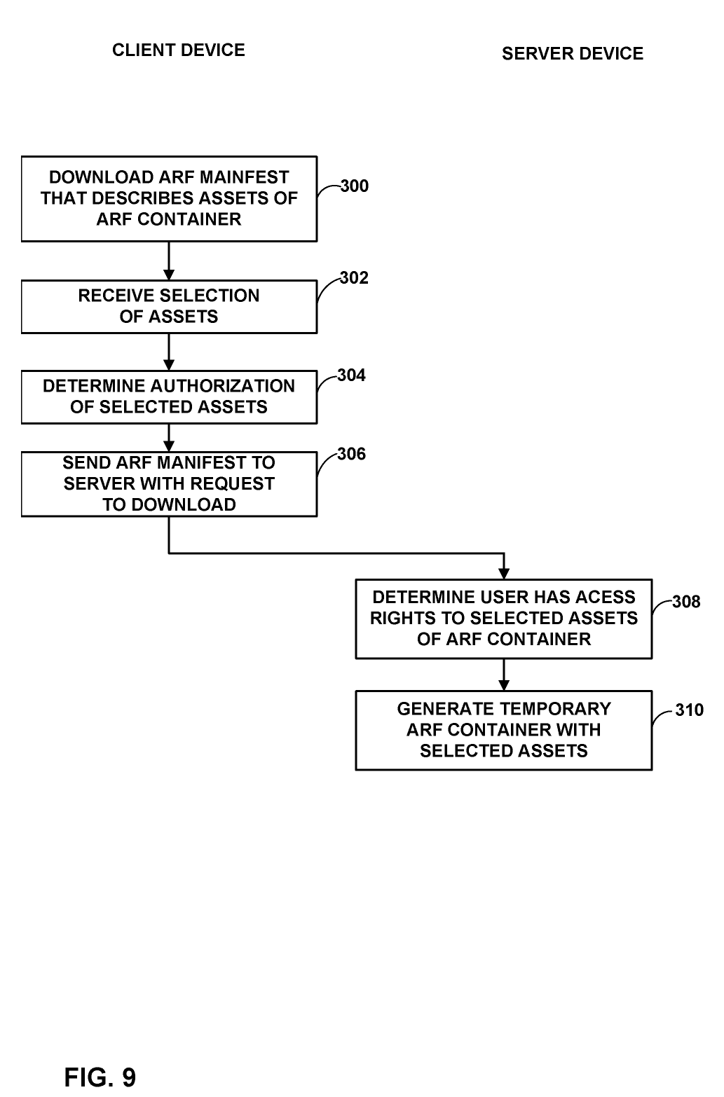

FIG. 9 is a flowchart illustrating another example for partial access to an avatar representation format container per techniques of this disclosure. In this example, initially, a client device downloads an ARF manifest that describes assets of an ARF container (300). The client device then receives, from a user of the client device, a selection of the assets (302). The client device then determines an authorization of the ARF manifest with the selected assets (304). The client device then sends the ARF manifest to a server with a download request (306).

To determine the authorization and request the download, the client device may re-author the downloaded ARF manifest to generate a session-specific manifest file. This re-authored manifest may include only the asset identifiers and metadata corresponding to the subset of assets selected by the user, rather than the full list of assets present in the original ARF container. By sending this re-authored manifest to the server device, the client device may explicitly define the scope of the request, thereby ensuring that the server device validates access rights and generates a temporary container restricted to the specific assets chosen for the current session.

The server device determines, in this example, that the user of the client device has access rights to the selected assets of the ARF container (308). Thus, the server device generates a temporary ARF container with the selected assets and sends the temporary ARF container to the user (310).

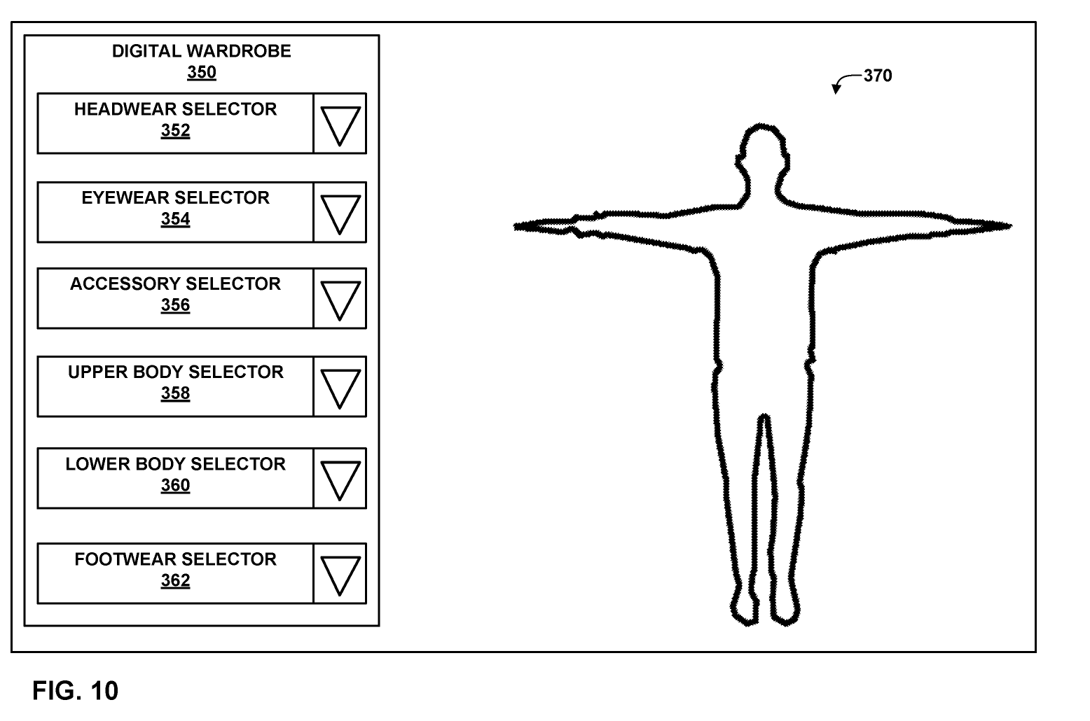

FIG. 10 is a conceptual diagram illustrating an example graphical user interface (GUI) for selecting digital assets to be worn by an avatar of a user during an AR media communication session. In this example, the GUI of FIG. 10 depicts avatar 370 and digital wardrobe 350. Digital wardrobe 350 represents an interface through which a user may browse and select specific digital assets from a main ARF container to apply to avatar 370. The user may interact with digital wardrobe 350 prior to initiating or joining an AR communication session to define an appearance for that specific session. Digital wardrobe 350 includes various selectors (e.g., drop-down menus, carousels, or grids) corresponding to different attachment points or categories of assets for avatar 370.

For example, digital wardrobe 350 includes headwear selector 352, which may enable selection of assets such as hats, caps, helmets, hair styles, headbands, headphones, or the like. Eyewear selector 354 may enable selection of assets such as prescription glasses, sunglasses, goggles, monocles, or virtual displays. Accessory selector 356 may enable selection of assets such as jewelry (e.g., earrings, necklaces), watches, scarves, ties, backpacks, or purses. Upper body selector 358 may enable selection of assets such as shirts, t-shirts, blouses, jackets, coats, sweaters, or hoodies. Lower body selector 360 may enable selection of assets such as pants, trousers, shorts, skirts, kilts, or leggings. Footwear selector 362 may enable selection of assets such as shoes, boots, sandals, sneakers, or slippers.

In some examples, digital wardrobe 350 may display snapshots, previews, or metadata for each asset to assist the user in making a selection. As the user selects an asset using one of selectors 352–362, the GUI may update avatar 370 to depict the selected asset, allowing the user to preview the appearance. Once the user finalizes the selection (e.g., by clicking a “confirm” or “save” button, not shown), the device (e.g., UE 200) may generate the avatar configuration data representing the selection of selected assets. This selection drives the creation of the ARF manifest file and the generation of the access token, ensuring that subsequent requests from peer devices retrieve only the specific assets chosen via digital wardrobe 350, rather than the entire library of assets stored in the main ARF container. This mechanism may provide privacy and security by limiting access to the full wardrobe, while enabling the authorized rendering of the selected assets for the avatar configuration.

To facilitate the user’s selection, digital wardrobe 350 may use various specific selection criteria derived from the metadata associated with the assets. For example, the metadata may classify assets based on attributes such as season (e.g., summer or winter collections), occasion (e.g., formal, casual, or sportswear), brand, fabric type, texture quality, or rarity (e.g., standard or limited edition items). Furthermore, the snapshots or previews displayed in digital wardrobe 350 may include distinct visual aids, such as static images showing how a particular asset set looks in isolation, as well as dynamic previews rendering how the user's specific avatar looks when wearing the selected asset. These granular selection criteria and preview options may enable the user to precisely curate their appearance before initiating the AR communication session.

In response to receiving the final confirmation of the selection from the user, the processing system of the device (e.g., UE 200) may execute a filtering algorithm to generate the ARF manifest file. The processing system may query an index of the main ARF container using the selected metadata attributes (e.g., “Season=Winter” AND “Type=Hat”) to identify the specific asset identifiers corresponding to the user’s selection. The processing system may then populate the “list of asset identifiers” field in the JavaScript Object Notation (JSON) structure of the ARF manifest file with these identified asset identifiers. This mapping process may ensure that the ARF manifest file accurately reflects the visual appearance composed by the user in the digital wardrobe 350, while excluding asset identifiers for non-selected items (e.g., “Season=Summer”) from the manifest to prevent unauthorized or unnecessary retrieval by peer devices.

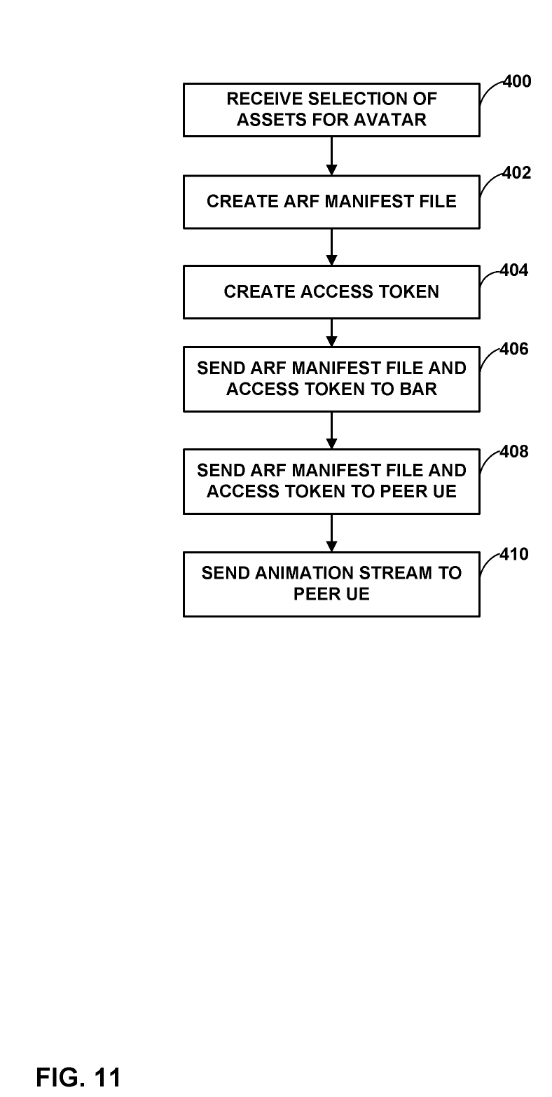

FIG. 11 is a flowchart illustrating an example method of receiving a selection of assets to be presented with an avatar during an AR communication session and authorizing access to the selected assets per techniques of this disclosure. The method of FIG. 11 may be performed by a user equipment (UE) device, such as UE 12 of FIG. 1, UE 182 of FIG. 4, UE 200 of FIG. 5, or sending device 236 of FIG. 6. For purposes of example, the method of FIG. 11 is explained with respect to sending device 236 of FIG. 6

Initially, sending device 236 receives avatar configuration data representing selected assets from available assets for an avatar from a user of sending device 236 (400). The avatar represents the user in a virtual scene for an AR communication session, e.g., with receiving device 240. In some examples, sending device 236 receives the selected assets via a graphical user interface (GUI) from the user, such as digital wardrobe 350 described with respect to FIG. 10 above.

Sending device 236 creates an avatar representation format (ARF) manifest file including data representing the selected assets from the available assets (402). The ARF manifest file may include one or more of user information for the user, an identifier of a main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets. In some examples, sending device 236 may sign a hash of at least a portion of the ARF manifest file with a private key of the user to form a signature for the ARF manifest file.

Sending device 236 creates or obtains an access token indicating that one or more other participants in the AR communication session are authorized to access the selected assets and the avatar (404).

Sending device 236 sends the ARF manifest file and the access token to a base avatar repository (BAR) (406). Sending device 236 may also send the signature for the ARF manifest file to the base avatar repository to authenticate the ARF manifest file to the BAR.

Sending device 236 also sends the ARF manifest file and the access token to one or more peer network devices of the one or more other participants in the AR communication session (408). In some examples, sending device 236 may send the ARF manifest file in a session description protocol (SDP) message including an SDP attribute indicating the ARF manifest file. The SDP attribute may have a format of “a=arf-manifest: URL time-frame.”

In this syntax, the “URL” parameter specifies the network address of the base avatar repository or the specific location of the ARF manifest file. The “time-frame” parameter indicates a validity period for the URL or the associated access token. For example, the time-frame may define a duration (e.g., in seconds) or an absolute expiration timestamp during which the recipient is authorized to access the selected assets. If the time-frame expires, the receiving device may be required to request a new manifest or access token from UE 200 to continue accessing the content.

During the AR communication session, sending device 236 determines movements of the user of sending device 236 (e.g., body and/or facial movements). Sending device 236 generates an animation stream representing the movements of the user (e.g., joint rotations and/or blendshapes). Sending device 236 sends the animation stream to the peer network devices of the participants in the AR communication session to cause the peer network devices to animate the avatar and the selected assets according to the animation stream (410).

In this manner, the method of FIG. 11 represents an example of a method of communicating augmented reality (AR) media data, including: receiving avatar configuration data representing a selection of selected assets from available assets for an avatar of a user, the avatar representing the user in a virtual scene for an AR communication session; creating an avatar representation format (ARF) manifest file including data representing the selection of selected assets from the available assets; and sending the ARF manifest file and an access token indicating that a participant in the AR communication session is authorized to access the selected assets to a base avatar repository.

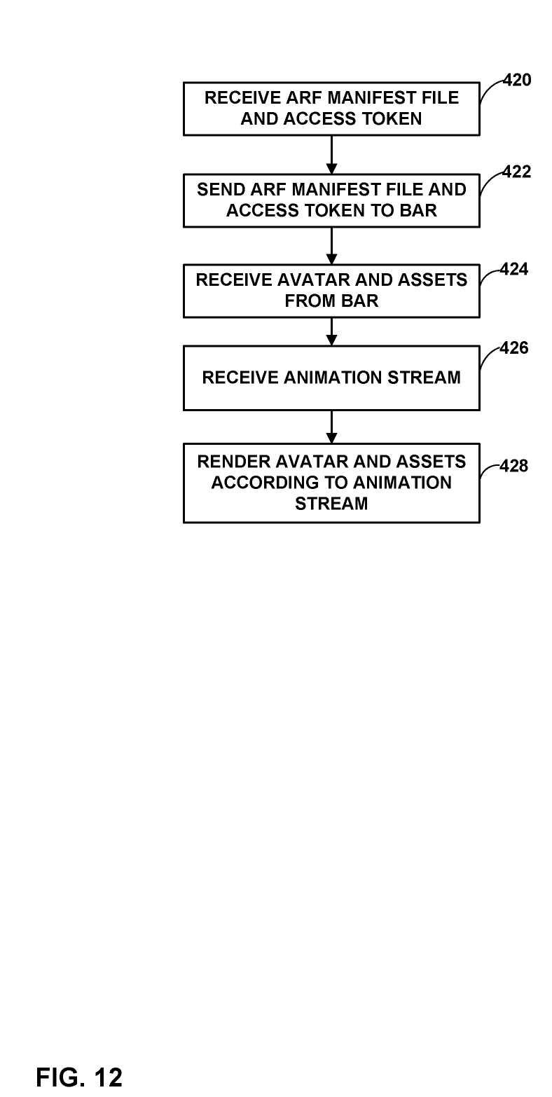

FIG. 12 is a flowchart illustrating an example method of retrieving assets to be presented with an avatar during an AR communication session per techniques of this disclosure. The method of FIG. 12 may be performed by a user equipment (UE) device, such as UE 14 of FIG. 1, XR server device 110 of FIG. 2, rendering components 174 of FIG. 3, UE 184 of FIG. 4, UE 200 of FIG. 5, or receiving device 240 of FIG. 6. For purposes of example, the method of FIG. 12 is explained with respect to receiving device 240 of FIG. 6.

Initially, receiving device 240 receives an avatar representation format (ARF) manifest file associated with an access token for a main ARF container including assets for an avatar associated with a participant in an AR communication session and an access token (420). The ARF manifest file includes data representing selected assets for the avatar to be used during the AR communication session. In some examples, receiving device 240 receives the ARF manifest file from a peer network device of the participant in the AR communication session. The peer network device may comprise a user equipment (UE) device, such as sending device 236 of FIG. 6. The ARF manifest file may include one or more of user information for the participant in the AR communication session, an identifier of the main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets.

Receiving device 240 sends a request including the ARF manifest file and the access token to request retrieval of the avatar and the selected assets (422). The ARF manifest file may include data representing a network location of a base avatar repository (BAR) that hosts the avatar and the assets for the avatar. In such examples, sending the request for the selected assets includes sending the request for the selected assets to the BAR indicated in the ARF manifest file.

Receiving device 240 receives the selected assets in response to the request (424). If the request included a request for the avatar, receiving the selected assets further comprises receiving a base mesh for the avatar, blendshapes for the avatar, and a skeleton and joints for the avatar. By utilizing the manifest and access token, receiving device 240 retrieves only the specific subset of assets used for the session, which may reduce bandwidth consumption compared to downloading the full main ARF container. Likewise, the access token may only grant receiving device 240 access to the selected assets, thereby preserving security to the full wardrobe of assets for the participant corresponding to the avatar.

Receiving device 240 receives an animation stream from a peer network device of the participant in the AR communication session (426). Receiving device 240 animates the avatar, including animating the selected assets, according to the animation stream (428). Receiving device 240 may render the animated avatar and selected assets for presentation on a display.

In this manner, the method of FIG. 12 represents an example of a method of communicating augmented reality (AR) media data, including: receiving an avatar representation format (ARF) manifest file associated with an access token for a main ARF container including assets for an avatar associated with a participant in an AR communication session; receiving data representing selected assets for the avatar; sending a request for the selected assets, the request including data representing the access token; and receiving the selected assets in response to the request.

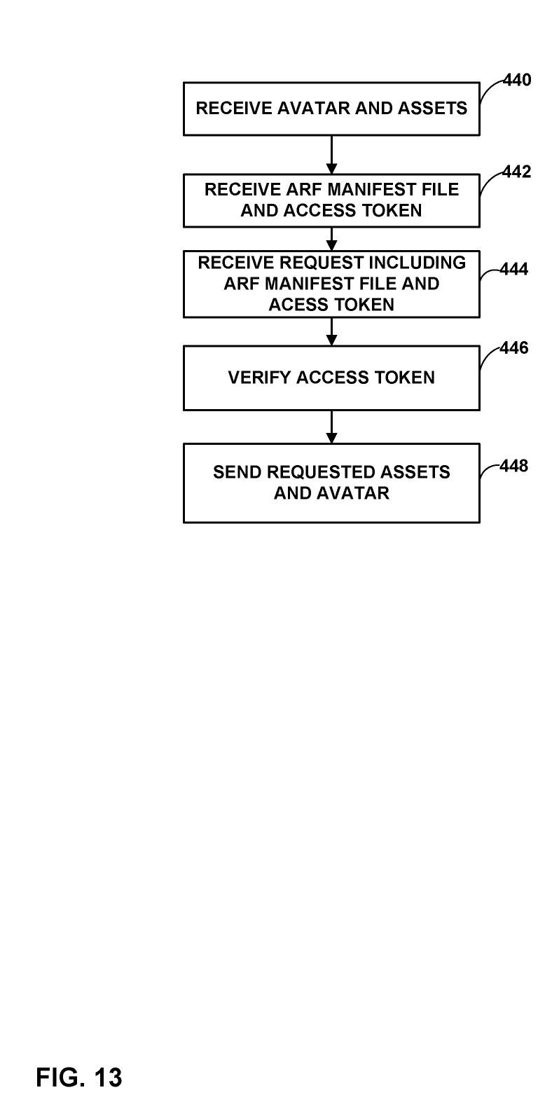

FIG. 13 is a flowchart illustrating an example method of a base avatar repository (BAR) device receiving an avatar and assets for the avatar, authorization to access a selected subset of the assets, and sending the selected subset of the assets to a participant in an AR communication session per techniques of this disclosure. The method of FIG. 13 may be performed by a device such as shared space server 180 of FIG. 4 or digital asset repository (DAR) device 232 of FIG. 6. For purposes of example, the method of FIG. 13 is explained with respect to DAR device 232 of FIG. 6.

Initially, DAR device 232 receives an avatar and a full set of assets for the avatar for a user of a first user equipment (UE) device (440). DAR device 232 may receive the avatar and the assets from the first UE device associated with the user. DAR device 232 stores the avatar and the full set of assets in a main avatar representation format (ARF) container.

DAR device 232 later receives an ARF manifest file and an access token from the first UE device (442). The ARF manifest file represents a selection of assets for the avatar of the user to represent the user in a virtual scene for an AR communication session. The access token indicates that the selection of the assets can be retrieved by one or more other participants in the AR communication session. The ARF manifest file may include one or more of user information for the user, an identifier of the main ARF container, a list of asset identifiers for the selection of the assets, data representing available levels of detail (LOD) for the avatar and the selection of the assets, data representing compressors to be used to decode the avatar and the selection of the assets, or digital rights management (DRM) information for gaining access to the avatar and the selection of the assets.

In some examples, DAR device 232 may further verify the authenticity of the ARF manifest file. For instance, DAR device 232 may receive a signature of a hash of at least a portion of the ARF manifest file, signed using a private key of the user, from the first UE device. DAR device 232 may apply a public key of the user to the signature to produce a reconstructed hash value. DAR device 232 may also calculate a calculated hash value of the at least portion of the ARF manifest file. DAR device 232 may verify the ARF manifest file as belonging to the user when the calculated hash value matches the reconstructed hash value.

DAR device 232 then receives a request to access the selection of the assets from a second UE device, the request including the ARF manifest file and the access token (444). The second UE device corresponds to one of the other participants in the AR communication session.

DAR device 232 validates the access token (446). Validating the access token may include comparing the data corresponding to the access token received from the second UE device with the access token received from the first UE device to ensure a match.

In response to validating the access token, DAR device 232 sends the selected assets and the avatar to the second UE device (448). Sending the selected assets may include generating a temporary ARF container including the selection of the assets and excluding other assets of the main ARF container. DAR device 232 may send the temporary ARF container to the second UE device. By generating the temporary container based on the manifest and token, DAR device 232 may ensure that the second UE device receives only the authorized subset of assets and the avatar used for the session, preserving bandwidth and security of the avatar and assets.

In this manner, the method of FIG. 13 represents an example of a method of communicating augmented reality (AR) media data, including: receiving, by an avatar repository device, an avatar representation format (ARF) manifest file and an access token from a first user equipment (UE) device associated with a user who participates in an AR communication session, the ARF manifest file representing a selection of assets for an avatar of the user to represent the user in a virtual scene for the AR communication session, the access token indicating that the selection of the assets can be retrieved by a participant in the AR communication session, the avatar repository device storing a main ARF container including the avatar and a full set of assets for the avatar; receiving, by the avatar repository device, a request to access the selection of the assets from a second UE device, the second UE device corresponding to the participant in the AR communication session, and the request including data corresponding to the access token; and in response to validating the access token, sending, by the avatar repository device, the selection of the assets to the second UE device.

Various examples of the techniques of this disclosure are summarized in the following clauses:

Clause 1: A method of communicating augmented reality (AR) media data, the method comprising: receiving an avatar representation format (ARF) manifest file associated with an access token for a main ARF container including assets for an avatar associated with a participant in an AR communication session; receiving data representing selected assets for the avatar; sending a request for the selected assets, the request including data representing the access token; and receiving the selected assets in response to the request.

Clause 2: A method of communicating augmented reality (AR) media data, the method comprising: receiving avatar configuration data representing a selection from available assets for an avatar of a user, the avatar representing the user in a virtual scene for an AR communication session; creating a manifest file including data representing the selection from the available assets; and sending the manifest file and an access token indicating that a participant in the AR communication session is authorized to access the assets corresponding to the selection to a base avatar repository.

Clause 3: A method of communicating augmented reality (AR) media data, the method comprising: receiving, by an avatar repository device, a manifest file and an access token from a first user equipment (UE) device associated with a user who participates in an AR communication session, the manifest file representing a selection of assets for an avatar of the user to represent the user in a virtual scene for the AR communication session, the access token indicating that the selection of the assets can be retrieved by a participant in the AR communication session; receiving, by the avatar repository device, a request to access the selection of the assets from a second UE device, the second UE device corresponding to the participant in the AR communication session, and the request including data corresponding to the access token; and in response to validating the access token, sending, by the avatar repository device, the selection of the assets to the second UE device.

Clause 4: The method of clause 3, wherein the avatar corresponds to a set of assets stored in a main avatar representation format (ARF) container, and wherein sending the selection of the assets comprises: generating a temporary ARF container including the selection of the assets and excluding other assets of the main ARF container; and sending the temporary ARF container to the second UE device.

Clause 5: A device for communicating augmented reality (AR) media data, the device comprising one or more means for performing the method of any of clauses 1–4.

Clause 6: The device of clause 5, wherein the one or more means comprise a processing system implemented in circuitry and a memory configured to store an avatar for a user who participates in an AR communication session.

Clause 7: A device for communicating augmented reality (AR) media data, the device comprising: means for receiving an avatar representation format (ARF) manifest file associated with an access token for a main ARF container including assets for an avatar associated with a participant in an AR communication session; means for receiving data representing selected assets for the avatar; means for sending a request for the selected assets, the request including data representing the access token; and means for receiving the selected assets in response to the request.

Clause 8: A device for communicating augmented reality (AR) media data, the device comprising: means for receiving avatar configuration data representing a selection from available assets for an avatar of a user, the avatar representing the user in a virtual scene for an AR communication session; means for creating a manifest file including data representing the selection from the available assets; and means for sending the manifest file and an access token indicating that a participant in the AR communication session is authorized to access the assets corresponding to the selection to a base avatar repository.

Clause 9: An avatar repository device for communicating augmented reality (AR) media data, the avatar repository device comprising: means for receiving a manifest file and an access token from a first user equipment (UE) device associated with a user who participates in an AR communication session, the manifest file representing a selection of assets for an avatar of the user to represent the user in a virtual scene for the AR communication session, the access token indicating that the selection of the assets can be retrieved by a participant in the AR communication session; receiving a request to access the selection of the assets from a second UE device, the second UE device corresponding to the participant in the AR communication session, and the request including data corresponding to the access token; and means for sending, in response to validating the access token, the selection of the assets to the second UE device.

Clause 10: A method of communicating augmented reality (AR) media data, the method comprising: receiving an avatar representation format (ARF) manifest file associated with an access token for a main ARF container including assets for an avatar associated with a participant in an AR communication session; receiving data representing selected assets for the avatar; sending a request for the selected assets, the request including data representing the access token; and receiving the selected assets in response to the request.

Clause 11: The method of clause 10, wherein receiving the ARF manifest file and the data representing the selected assets comprises receiving the ARF manifest file and the data representing the selected assets from a peer network device of the participant in the AR communication session.

Clause 12: The method of clause 11, wherein the peer network device comprises a user equipment (UE) device.

Clause 13: The method of any of clauses 10–12, wherein the ARF manifest file includes data representing a network location of a base avatar repository (BAR) that hosts the avatar and the assets for the avatar.

Clause 14: The method of clause 13, wherein sending the request for the selected assets comprises sending the request for the selected assets to the BAR indicated in the ARF manifest file.

Clause 15: The method of any of clauses 10–14, wherein the request further comprises a request for the avatar, and wherein receiving further comprises receiving a base mesh for the avatar.

Clause 16: The method of any of clauses 10–15, further comprising: receiving an animation stream from a peer network device of the participant in the AR communication session; and animating the avatar, including animating the selected assets, according to the animation stream.

Clause 17: The method of any of clauses 10–16, wherein the ARF manifest file includes one or more of user information for the participant in the AR communication session, an identifier of the main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets.

Clause 18: A method of communicating augmented reality (AR) media data, the method comprising: receiving avatar configuration data representing a selection of selected assets from available assets for an avatar of a user, the avatar representing the user in a virtual scene for an AR communication session; creating an avatar representation format (ARF) manifest file including data representing the selection of selected assets from the available assets; and sending the ARF manifest file and an access token indicating that a participant in the AR communication session is authorized to access the selected assets to a base avatar repository.

Clause 19: The method of clause 18, wherein receiving the avatar configuration data comprises receiving the selection of selected assets via a graphical user interface (GUI) from a user.

Clause 20: The method of any of clauses 18 and 19, further comprising sending the ARF manifest file to a peer network device of the participant in the AR communication session.

Clause 21: The method of clause 20, wherein sending the ARF manifest file comprises sending a session description protocol (SDP) message including an SDP attribute indicating the ARF manifest file, the SDP attribute having a format of “a=arf-manifest: URL time-frame.”

Clause 22: The method of any of clauses 18–21, further comprising: signing a hash of at least a portion of the ARF manifest file with a private key of the user to form a signature for the ARF manifest file; and sending the signature for the ARF manifest file to the base avatar repository.

Clause 23: The method of any of clauses 18–22, further comprising: during the AR communication session, determining movements of the user; generating an animation stream representing the movements of the user; and sending the animation stream to a peer network device of the participant in the AR communication session to cause the peer network device to animate the avatar and the selected assets according to the animation stream.

Clause 24: The method of any of clauses 18–23, wherein the ARF manifest file includes one or more of user information for the user, an identifier of a main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets.

Clause 25: A method of communicating augmented reality (AR) media data, the method comprising: receiving, by an avatar repository device, an avatar representation format (ARF) manifest file and an access token from a first user equipment (UE) device associated with a user who participates in an AR communication session, the ARF manifest file representing a selection of assets for an avatar of the user to represent the user in a virtual scene for the AR communication session, the access token indicating that the selection of the assets can be retrieved by a participant in the AR communication session, the avatar repository device storing a main ARF container including the avatar and a full set of assets for the avatar; receiving, by the avatar repository device, a request to access the selection of the assets from a second UE device, the second UE device corresponding to the participant in the AR communication session, and the request including data corresponding to the access token; and in response to validating the access token, sending, by the avatar repository device, the selection of the assets to the second UE device.

Clause 26: The method of clause 25, wherein the avatar corresponds to a set of assets stored in a main avatar representation format (ARF) container, and wherein sending the selection of the assets comprises: generating a temporary ARF container including the selection of the assets and excluding other assets of the main ARF container; and sending the temporary ARF container to the second UE device.

Clause 27: The method of any of clauses 25 and 26, wherein the request to access the selection of the assets includes the ARF manifest file.

Clause 28: The method of any of clauses 25–27, further comprising: receiving a signature of a hash of at least a portion of the ARF manifest file from the first UE device; applying a public key of the user to the signature to produce a reconstructed hash value; calculating a calculated hash value of the at least portion of the ARF manifest file; and verifying the ARF manifest file as belonging to the user when the calculated hash value matches the reconstructed hash value.

Clause 29: The method of any of clauses 25–28, wherein the ARF manifest file includes one or more of user information for the user, an identifier of the main ARF container including the avatar and the full set of assets for the avatar, a list of asset identifiers for the selection of the assets, data representing available levels of detail (LOD) for the avatar and the selection of the assets for the avatar, data representing compressors to be used to decode the avatar and the selection of the assets, or digital rights management (DRM) information for gaining access to the avatar and the selection of the assets.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating augmented reality (AR) media data, the method comprising:
receiving an avatar representation format (ARF) manifest file associated with an access token for a main ARF container including assets for an avatar associated with a participant in an AR communication session;
receiving data representing selected assets for the avatar;
sending a request for the selected assets, the request including data representing the access token; and
receiving the selected assets in response to the request.

2. The method of claim 1, wherein receiving the ARF manifest file and the data representing the selected assets comprises receiving the ARF manifest file and the data representing the selected assets from a peer network device of the participant in the AR communication session.

3. The method of claim 2, wherein the peer network device comprises a user equipment (UE) device.

4. The method of claim 1, wherein the ARF manifest file includes data representing a network location of a base avatar asset repository (BAR) that hosts the avatar and the assets for the avatar.

5. The method of claim 4, wherein sending the request for the selected assets comprises sending the request for the selected assets to the BAR indicated in the ARF manifest file.

6. The method of claim 1, wherein the request further comprises a request for the avatar, and wherein receiving further comprises receiving a base mesh for the avatar.

7. The method of claim 1, further comprising:
receiving an animation stream from a peer network device of the participant in the AR communication session; and
animating the avatar, including animating the selected assets, according to the animation stream.

8. The method of claim 1, wherein the ARF manifest file includes one or more of user information for the participant in the AR communication session, an identifier of the main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets.

9. A method of communicating augmented reality (AR) media data, the method comprising:
receiving avatar configuration data representing a selection of selected assets from available assets for an avatar of a user, the avatar representing the user in a virtual scene for an AR communication session;
creating an avatar representation format (ARF) manifest file including data representing the selection of selected assets from the available assets; and
sending the ARF manifest file and an access token indicating that a participant in the AR communication session is authorized to access the selected assets to a base avatar repository.

10. The method of claim 9, wherein receiving the avatar configuration data comprises receiving the selection of selected assets via a graphical user interface (GUI) from the user.

11. The method of claim 9, further comprising sending the ARF manifest file to a peer network device of the participant in the AR communication session.

12. The method of claim 11, wherein sending the ARF manifest file comprises sending a session description protocol (SDP) message including an SDP attribute indicating the ARF manifest file, the SDP attribute having a format of “a=arf-manifest: URL time-frame.”

13. The method of claim 9, further comprising:
signing a hash of at least a portion of the ARF manifest file with a private key of the user to form a signature for the ARF manifest file; and
sending the signature for the ARF manifest file to the base avatar repository.

14. The method of claim 9, further comprising:
during the AR communication session, determining movements of the user;
generating an animation stream representing the movements of the user; and
sending the animation stream to a peer network device of the participant in the AR communication session to cause the peer network device to animate the avatar and the selected assets according to the animation stream.

15. The method of claim 9, wherein the ARF manifest file includes one or more of user information for the user, an identifier of a main ARF container including the avatar and the selected assets for the avatar, a list of asset identifiers for the selected assets, data representing available levels of detail (LOD) for the avatar and the selected assets for the avatar, data representing compressors to be used to decode the avatar and the selected assets, or digital rights management (DRM) information for gaining access to the avatar and the selected assets.

16. A method of communicating augmented reality (AR) media data, the method comprising:
receiving, by an avatar repository device, an avatar representation format (ARF) manifest file and an access token from a first user equipment (UE) device associated with a user who participates in an AR communication session, the ARF manifest file representing a selection of assets for an avatar of the user to represent the user in a virtual scene for the AR communication session, the access token indicating that the selection of the assets can be retrieved by a participant in the AR communication session, the avatar repository device storing a main ARF container including the avatar and a full set of assets for the avatar;
receiving, by the avatar repository device, a request to access the selection of the assets from a second UE device, the second UE device corresponding to the participant in the AR communication session, and the request including data corresponding to the access token; and
in response to validating the access token, sending, by the avatar repository device, the selection of the assets to the second UE device.

17. The method of claim 16, wherein the avatar corresponds to a set of assets stored in a main avatar representation format (ARF) container, and wherein sending the selection of the assets comprises:
generating a temporary ARF container including the selection of the assets and excluding other assets of the main ARF container; and
sending the temporary ARF container to the second UE device.

18. The method of claim 16, wherein the request to access the selection of the assets includes the ARF manifest file.

19. The method of claim 16, further comprising:
receiving a signature of a hash of at least a portion of the ARF manifest file from the first UE device;
applying a public key of the user to the signature to produce a reconstructed hash value;
calculating a calculated hash value of the at least portion of the ARF manifest file; and
verifying the ARF manifest file as belonging to the user when the calculated hash value matches the reconstructed hash value.

20. The method of claim 16, wherein the ARF manifest file includes one or more of user information for the user, an identifier of the main ARF container including the avatar and the full set of assets for the avatar, a list of asset identifiers for the selection of the assets, data representing available levels of detail (LOD) for the avatar and the selection of the assets for the avatar, data representing compressors to be used to decode the avatar and the selection of the assets, or digital rights management (DRM) information for gaining access to the avatar and the selection of the assets.
